(19) United States
(12) Patent Application Publication
(10) Pub. No.: US 2024/0425394 A1
(43) Pub. Date: Dec. 26, 2024

(54) COMPOSITE OZONE CATALYST, PREPARATION METHOD AND USE THEREOF

(71) Applicant: Jiangsu Environmental Engineering Technology Co., Ltd, Nanjing City (CN)

(72) Inventors: Yong TU, Nanjing City (CN); Yong CHEN, Nanjing City (CN); Tao CUI, Nanjing City (CN); Boming FU, Nanjing City (CN); Yaohui ZHANG, Nanjing City (CN); Yiqiang CHEN, Nanjing City (CN); Hong LING, Nanjing City (CN); Yang LIU, Nanjing City (CN)

(21) Appl. No.: 18/748,467

(22) Filed: Jun. 20, 2024

(30) Foreign Application Priority Data
Jun. 20, 2023 (CN) 2023107295510

(51) Int. Cl. C02F 1/72; B01J 21/18; B01J 27/24; B01J 35/51; B01J 37/00; B01J 37/02; B01J 37/08; C02F 1/78; C02F 101/30; C02F 101/34; C02F 101/38

(52) U.S. Cl. CPC C02F 1/725; B01J 21/18; B01J 27/24; B01J 35/51; B01J 37/0018; B01J 37/0063; B01J 37/0203; B01J 37/088; C02F 1/78; C02F 2101/308; C02F 2101/345; C02F 2101/38

(57) ABSTRACT

A composite ozone catalyst, a preparation method and use thereof. The composite ozone catalyst of the present invention includes a co-carrier mixed with biochar and a silica-alumina-based material, and a metal element and a nitrogen element supported on the co-carrier. The preparation method includes mixing the biochar and the silica-alumina-based material powder and then placing the same in a metal precursor solution for impregnation, adding a polyvinyl pyrrolidone solution to the impregnated material, wet granulating to form a spherical material, and calcining the spherical material to obtain the composite ozone catalyst. The composite ozone catalyst has low production cost, simple preparation processes, good catalytic performance, and strong stability, which can meet the high-efficiency and low-consumption requirements of ozone catalytic oxidation in the advanced treatment of industrial wastewater.

### TECHNICAL FIELD

The present invention belongs to the technical field of water treatment, and particularly relates to a composite ozone catalyst, a preparation method and use thereof.

### BACKGROUND ART

Advanced oxidation technology has the effect of enhanced removal for residual refractory organics in tailwater and is often used as a core process for the advanced treatment of chemical tailwater. Among others, ozone catalytic oxidation technology is one of the representative technologies for the advanced treatment of industrial tailwater.

Heterogeneous ozone catalytic oxidation technology, as one of ozone catalytic oxidation technologies, has the advantages of fast reaction, clean products, strong oxidation capacity, weak selectivity, and no secondary pollution, and does not require continuous addition of catalysts, so it is widely used in industrialization. However, the existing heterogeneous ozone catalytic oxidation processes still have some problems, such as insufficient catalytic performance, poor stability, and low treatment efficiency for wastewater. There is a significant bottleneck in the treatment efficiency, especially for wastewater with low pollutant concentration, high salinity, and poor mass transfer. So far, the most widely used heterogeneous ozone catalytic processes are the ozone-packed bed reaction process and fluidized bed reaction process, but both have defects. Particle catalysts are generally used in packed bed reactors. Since the ozone catalytic oxidation reaction site is mainly on the surface of a catalyst, more than about 90% of the internal structure of the particle catalyst cannot directly participate in catalysis. A large number of internal structures not only reduce the bulk density of active sites but also lead to material waste and increased costs. In addition, the continuous deposition and growth of irons such as Ca²⁺, mg²⁺, CO₃²⁻, and SO₄²⁻ in wastewater on the surface of the static particle catalyst may cause the hardening and failure of the catalyst bed, which seriously shortens the service life of the catalyst. Compared with the packed bed, powder catalysts are generally used in the fluidized bed process, which has the characteristics of high specific surface area, high mass transfer efficiency, light mass (easy to cause fluidization), and anti-scaling, but in practical use, it is difficult to separate and recover the powder catalysts.

Therefore, how to increase the active specific surface area of a catalyst as much as possible, reduce the catalyst mass, improve the interfacial mass transfer efficiency, and avoid catalyst pulverization to form an efficient ozone catalyst material independent of separation and recovery units based on this, so as to achieve the high efficiency and high stability (anti-scaling) of the catalytic process and promote the substantial reduction of the catalytic material and ozone dosage, are an important direction to break through the bottleneck of the existing technologies and realize the low-consumption and high-efficiency use of ozone catalytic oxidation.

### SUMMARY OF THE INVENTION

In view of the current situation of poor active sites and low mass transfer efficiency of particle catalysts in ozone catalysis, combined with the advantages of powder catalysts such as high specific surface area, high mass transfer efficiency, and light mass, and overcoming problems such as difficult separation and recovery, the present invention provides a composite ozone catalyst, a preparation method and use thereof. The composite ozone catalyst of the present invention has low production cost, simple preparation processes, good catalytic performance, and strong stability, which can meet the high-efficiency and low-consumption requirements of ozone catalytic oxidation in the advanced treatment of industrial wastewater.

According to a first aspect of the present invention, provided is a composite ozone catalyst, comprising a co-carrier mixed with biochar and a silica-alumina-based material, and a metal element and a nitrogen element supported on the co-carrier.

Optionally, the source of the nitrogen element supported comprises polyvinyl pyrrolidone.

Optionally, the biochar comprises any one or a combination of straw, seed shell, bark, and sawdust.

Optionally, the silica-alumina-based material comprises any one or a combination of alumina, ceramsite, or zeolite.

Optionally, the metal element comprises any one or a combination of iron, copper, manganese, cobalt, nickel, lanthanum, and cerium.

Optionally, the mass ratio of the biochar mixed with the silica-alumina-based material is 1:(2-10).

Optionally, the metal element comprises any one or a combination of copper, iron, manganese, and cerium, with a molar concentration ratio of n(Cu):n(Fe):n(Mn):n(Ce)=1:(0-0.8):(0-0.6):(0-0.4).

According to a second aspect of the present invention, provided is a preparation method for the composite ozone catalyst, comprising mixing the biochar and the silica-alumina-based material and then placing the same in a metal precursor solution for impregnation, adding a polyvinyl pyrrolidone solution to the impregnated material, wet granulating to form a spherical material, and calcining the spherical material to obtain the composite ozone catalyst.

Optionally, the polyvinyl pyrrolidone solution has a concentration of 0.5-3 wt %.

Optionally, the metal precursor solution is an aqueous solution of a metal salt, and the metal salt is any one or a combination of at least two of metal citrate, metal acetate, metal sulfate, and metal nitrate.

Optionally, the impregnation comprises placing the mixed powder in the metal precursor solution with stirring, placing the same at 15-30° C. for aging, filtering to leave an impregnated powder, and drying the impregnated powder at a temperature of 80-120° C. for 6-24 h to obtain an impregnated material.

Optionally, the calcining comprises placing the spherical material in a nitrogen-protected furnace and subjecting to programmed temperature treatment under an N₂ atmosphere of 50-100 mL/min, including first raising the temperature from room temperature to 200° C. at 10° C./min and maintaining for 1 h; then raising to 500-600° C. at 5° C./min and maintaining for 2-4 h; and finally naturally cooling to room temperature, to obtain the composite ozone catalyst.

According to a third aspect of the present invention, provided is an ozone catalytic oxidation reactor for wastewater. The reactor is filled with the above composite ozone catalyst and/or the composite ozone catalyst prepared by the above preparation method.

Optionally, the filling ratio of the composite ozone catalyst in the reactor is 3%-15% of the total reactor volume.

According to a fourth aspect of the present invention, provided is the use of the above composite ozone catalyst or the composite ozone catalyst prepared by the above preparation method in wastewater treatment.

According to a fifth aspect of the present invention, as a more specific use, provided is a wastewater treatment method by ozone catalytic oxidation, comprising introducing the wastewater to be treated into the ozone catalytic oxidation reactor for wastewater containing the composite ozone catalyst for treatment.

Optionally, the treatment method comprises introducing ozone into the reactor; the ozone dosage is determined as O₃/ΔCOD=(1.0-2.5):1, where O₃ and COD have the same units, e.g., both mg/L.

Optionally, the O₃/ΔCOD ratio is (1.0-2.0):1 when the influent COD of the wastewater to be treated is 50-200 mg/L; the O₃/ΔCOD ratio is (1.5-2.5):1 when the influent COD of the wastewater to be treated >500 mg/L; where O₃ and COD have the same units, e.g., both mg/L.

The composite ozone catalyst of the present invention is a metal and nitrogen co-doped composite catalyst formed by supporting a metal oxide and doping the nitrogen element on the biochar and the silica-alumina-based material such as alumina, ceramsite, or zeolite as the co-carrier. By mixing the carrier, the mass (weight) of the catalyst can be reduced, which is beneficial for improving the subsequent fluidized expansion rate of the catalyst in the water treatment reactor. Further, the nitrogen element supported is derived from polyvinyl pyrrolidone. By adding polyvinyl pyrrolidone, the metal oxide has a high dispersion on the double-matrix co-carrier material, and more catalytic active sites are constructed. In the present invention, polyvinyl pyrrolidone has the dual function of both a polymer binder and a nitrogen-containing precursor substance, which can ensure a strong binding force for granulation molding and a high dispersion of the mixed powder and can also dope the nitrogen element to form oxygen vacancies to improve the catalytic performance.

In addition to the material components, the preparation method for the catalyst of the present invention adopts various powder mixing, precursor impregnation, and granulation molding processes. The prepared catalyst has a porous structure with micropores in an inner core. The doped metal element is attached to the surface and the inner core of the catalyst, and pollutants can pass through the pores in the inner core into a confined space, significantly increasing the reactive active sites and enhancing the catalytic oxidation capacity.

According to the present invention, the bottleneck in use of the ozone catalyst is broken through in various ways, such as reducing the self-weight of the catalyst, forming confined pores, and forming oxygen vacancies, such that the catalyst can improve the efficiency of catalytic ozonolysis to generate active free radicals in the advanced treatment of industrial wastewater by ozone catalytic oxidation. At the same time, the fluidized catalyst has higher utilization efficiency, and the ozone dosage is significantly reduced, which has a strong green and low-carbon technical performance and market value.

### BRIEF DESCRIPTION OF THE DRAWINGS

FIG. 1 is an FE-SEM image (20 μm) of a catalyst of an example of the present invention;

FIG. 2 is an FE-SEM image (10 μm) of a catalyst of an example of the present invention;

FIG. 3 is another FE-SEM image (10 μm) of a catalyst of an example of the present invention;

FIG. 4 is an EDS spectrogram (10 μm) of a catalyst of an example of the present invention;

FIG. 5 is an FT-IR infrared spectrogram of catalysts of Example 1 and Comparative Example 1 of the present invention; and

FIG. 6 is a Raman spectrogram of catalysts of Example 1 and Comparative Example 1 of the present invention.

### DETAILED DESCRIPTION OF THE INVENTION

The present invention provides a composite ozone catalyst comprising a co-carrier mixed with biochar and a silica-alumina-based material, and a metal element and a nitrogen element supported on the co-carrier.

According to the catalyst of the present invention, the silica-alumina-based material such as alumina powder, ceramsite powder, or zeolite powder is mixed with a biochar material to form a composite matrix material such as a silica-alumina-carbon matrix. The silica-alumina-based material includes a material containing silica and alumina, and representative materials are alumina, ceramsite, zeolite, and the like. By mixing the carrier, the mass (weight) of the catalyst can be reduced, which is beneficial for improving the subsequent fluidized expansion rate of the catalyst in the water treatment reactor. By co-doping the metal element and polyvinyl pyrrolidone, the metal oxide has a high dispersion on the co-carrier material, and more catalytic active sites are constructed.

Preferably, the catalyst of the present invention is a metal and nitrogen co-doped alumina-carbon-based composite catalyst formed by supporting the metal oxide and doping the nitrogen element on the biochar and alumina as the co-carrier.

Preferably, the nitrogen element supported is derived from polyvinyl pyrrolidone. Polyvinyl pyrrolidone (PVP) has the dual function of both a polymer binder and a nitrogen-containing precursor substance, which can ensure a strong binding force for granulation molding of mixed powder and can also dope the nitrogen element to form oxygen vacancies to improve the catalytic performance.

Preferably, the biochar comprises any one or a combination of straw, seed shell, bark, and sawdust.

Biochar is a carbide prepared by pyrolysis of biomass or solid waste and has the chemical advantages of rich low-cost matrix, batch preparation, and simple pretreatment. High-temperature pyrolysis is beneficial for the formation of a porous structure with a high specific surface area by facilitating the evaporation of volatile substances in the biochar raw material. The increase in the number of oxygen-bonded carbon groups formed at a higher pyrolysis temperature gives the biochar the ability to remove pollutants, which can facilitate the adsorption of O₃ on its surface and participate in the electron transfer process, making it a green and low-carbon matrix material. According to the present invention, the preferred source of biochar material has the characteristics of easy availability, low cost, large specific surface area, high carbon content, and the like.

Preferably, the metal element comprises any one or a combination of iron, copper, manganese, cobalt, nickel, lanthanum, and cerium. Compared with the catalysts using noble metals such as palladium and gold in the prior art, the metal raw material used in the present invention has a lower cost, which is beneficial for the large-scale production and industrial use of the composite ozone catalyst.

Preferably, the mass ratio of the biochar mixed with alumina, ceramsite, or zeolite is 1:(2-10). In some embodiments, the mix ratio is, for example, 1:(2-6), 1:(7-10), or 1:4, 1:8, 1:10, etc. The above ratio is the preferred ratio of the carbon-based material to the silica-alumina-based material. By reasonably increasing the proportion of carbon elements and decreasing the proportion of aluminum elements in the matrix, the mass of the catalyst can be optimized, and the fluidized expansion rate can be improved.

Preferably, the metal element supported on the catalyst is any one or a combination of copper, iron, manganese, and cerium, and the combination is carried out at a molar concentration ratio of n(Cu):n(Fe):n(Mn):n(Ce)=1:(0-0.8):(0-0.6):(0-0.4). For example, in some embodiments, where the metal element supported is a combination of copper, iron, and manganese, the three metals are combined at a molar ratio of n(Cu):n(Fe):n(Mn)=1:(0-0.8):(0-0.6). In some embodiments, where the metal element supported is a combination of copper, manganese, and cerium, the three metals are combined at a ratio of n(Cu):n(Mn):n(Ce)=1:(0-0.6):(0-0.4). In some embodiments, where the metal element supported is a combination of copper and manganese, the two metals are combined at a ratio of 1:(0-0.6). In some embodiments, where the metal element supported is a combination of copper and cerium, the two metals are combined at a ratio of 1:(0-0.4).

In some specific embodiments, the ratio of all metal elements supported on the catalyst, expressed as the mass ratio of the metal element to the carbon and nitrogen elements in the catalyst, is wt (Cu):wt(Fe):wt(Mn):wt(Ce):wt(C):wt(N)=1:(0.5-2.5):(0.5-2.0):(0.5-2.0):(5-30):(5-15).

The present invention further discloses a preparation method for the above composite ozone catalyst. Specifically, the method comprises mixing the biochar and the silica-alumina-based material, such as alumina powder and zeolite powder, and then placing the same in a metal precursor solution for impregnation, adding a polyvinyl pyrrolidone solution to the impregnated material, wet granulating to form a spherical material, and calcining the spherical material to obtain the composite ozone catalyst.

Taking alumina as an example of the silica-alumina-based material, more specifically, the preparation method comprises:

### 1) Pulverizing and Mixing

The biochar material is pulverized into a certain mesh of powder, washed 2-3 times with water, filtered with a sieve to remove the micro impurities and ash contained in the biochar material such as sawdust, and dried in an oven at 60° C. The alumina powder is uniformly mixed with the pulverized carbon material, called “mixed powder.” The biochar and alumina matrix may be in powder or particle form; if in particle, it needs to be pulverized, and the mesh number after pulverization is 50-100 meshes.

### 2) Impregnating

Ferric citrate, copper acetate, manganese sulfate, cerium ammonium nitrate, and other metal salts were dissolved in water to prepare a precursor solution. The mixed powder is placed in the precursor solution with stirring, placed at room temperature for aging, and filtered to leave an impregnated powder. The metal precursor solution is an aqueous solution of a metal salt, and the metal salt may be a metal organic salt or a metal inorganic salt, preferably any one or a combination of at least two of metal citrate, metal acetate, metal sulfate, and metal nitrate.

### 3) Granulating

The impregnated carbon and alumina powder is added with a certain concentration of polyvinyl pyrrolidone (PVP) solution and then granulated by a wet granulation method to form a three-dimensional spherical material with a particle size of 2-10 mm. Preferably, the concentration of the polyvinyl pyrrolidone, as a nitrogen-containing precursor and a polymeric binder, prepared into an aqueous solution during granulation is 0.5%-3%.

### 4) Calcining

After the completion of granulation, the spherical material is placed in a nitrogen-protected furnace and subjected to programmed temperature treatment under an N₂ atmosphere (50-100 mL/min) preparation, including first raising the temperature from room temperature to 200° C. at 10° C./min and maintaining for 1 h; then raising to 500-600° C. at 5° C./min and maintaining for 2-4 h; and finally naturally cooling to room temperature, to obtain the composite ozone catalyst described in the present invention.

Based on the above composite ozone catalyst and/or the composite ozone catalyst prepared by the above preparation method, the present invention further provides an ozone catalytic oxidation reactor for wastewater. The reactor is filled with the above composite ozone catalyst of the present invention. The reactor may be a fluidized bed reactor. Preferably, the filling rate of the composite ozone catalyst in the reactor is 3%-15% (v/v) of the total reactor volume. The composite ozone catalyst of the present invention has good catalytic performance and can effectively promote the efficient progress of the ozone catalytic reaction at a relatively small amount of use.

Based on the above solutions, the present invention further discloses a wastewater treatment method by ozone catalytic oxidation, comprising introducing the wastewater to be treated into the above ozone catalytic oxidation reactor for wastewater treatment. Ozone is introduced into the reactor during treatment. The preferred ozone dosage is an O₃/ΔCOD ratio of (1.0-2.5):1. Further, the O₃/ΔCOD ratio is (1.0-2.0):1 when the influent COD of the wastewater to be treated is 50-200 mg/L; the O₃/ΔCOD ratio is (1.5-2.5):1 when the influent COD of the wastewater to be treated ≥500 mg/L. ΔCOD refers to the difference between the influent COD of the wastewater to be treated and the target effluent COD. In the ratio O₃/ΔCOD, O₃ and ΔCOD have the same units, e.g., both mg/L.

It can be seen from the above solutions that the composite ozone catalyst of the present invention is a metal and nitrogen co-doped composite catalyst formed by supporting the metal oxide and doping the nitrogen element on the biochar and the silica-alumina-based material such as alumina, ceramsite, or zeolite as the co-carrier and utilizing the characteristics of high-temperature resistance, adhesiveness, reducibility, and nitrogen-containing elements of polyvinyl pyrrolidone (PVP).

Compared with conventional catalysts and preparation methods, the present invention has the following advantages.

First, by increasing the proportion of carbon elements and decreasing the proportion of aluminum elements in the matrix, the mass of the catalyst is reduced, and the fluidization expansion rate is improved. Second, by co-doping the metal element and the nitrogen element, the metal oxide has a high dispersion on the composite matrix material such as silica-alumina-carbon matrix, and more catalytic active sites are constructed. Third, polyvinyl pyrrolidone, as a binder and a nitrogen-containing precursor substance, has reducibility that can reduce a part of metal oxide during the doping of the nitrogen element to form a certain number of oxygen vacancies on the surface of the metal oxide without changing the crystal form of the metal oxide, thereby improving the catalytic activity and stability of the metal oxide.

Therefore, according to the present invention, the bottleneck in use of the ozone catalyst is improved in three ways, i.e., reducing the self-weight of the catalyst, creating confined pores to increase the bulk density of active sites, and forming oxygen vacancies, such that the catalyst can improve the efficiency of catalytic ozonolysis to generate active free radicals in the advanced treatment of industrial wastewater by ozone catalytic oxidation. At the same time, the fluidized catalyst has higher utilization efficiency, and the ozone dosage is significantly reduced, which has a strong green and low-carbon technical performance and market value.

The technical solutions of the present invention will be further described below with reference to specific examples.

### Example 1: Preparation of Catalyst

The catalyst was prepared according to the following steps:

### 1. Pulverizing and Mixing

Seed shell was selected as a biochar matrix material, pulverized to 50 meshes, washed 2 times with water, filtered with a sieve to remove the micro impurities and ash contained in the seed shell, and dried in an oven at 60° C. The alumina powder was uniformly mixed with the pulverized carbon material at a mass ratio of 1:5, called “mixed powder.”

### 2. Impregnating

Three metal salts, ferric citrate, copper acetate, and manganese sulfate, were weighed at a molar ratio of n(Cu):n(Fe):n(Mn)=1:0.2:0.3 and dissolved in water to prepare a precursor solution. The mixed powder was placed in the precursor solution with stirring at a temperature of 15° C., placed at room temperature for aging for 12 h, and filtered to leave an impregnated powder. The powder was dried in an oven at a temperature of 101° C. for 24 h.

### 3. Granulating

The impregnated mixed powder was added with a polyvinyl pyrrolidone (PVP) solution with a mass fraction of 2% and then granulated by a wet granulation method to form a three-dimensional spherical material with a particle size of 3-5 mm.

### 4. Calcining

After the completion of granulation, the spherical material was placed in a nitrogen-protected furnace and subjected to programmed temperature treatment under an N₂ atmosphere (50-100 mL/min) preparation, including first raising the temperature from room temperature to 200° C. at 10° C./min and maintaining for 1 h; then raising to 500° C. at 5° C./min and maintaining for 3 h; and finally naturally cooling to room temperature, to obtain the catalyst material.

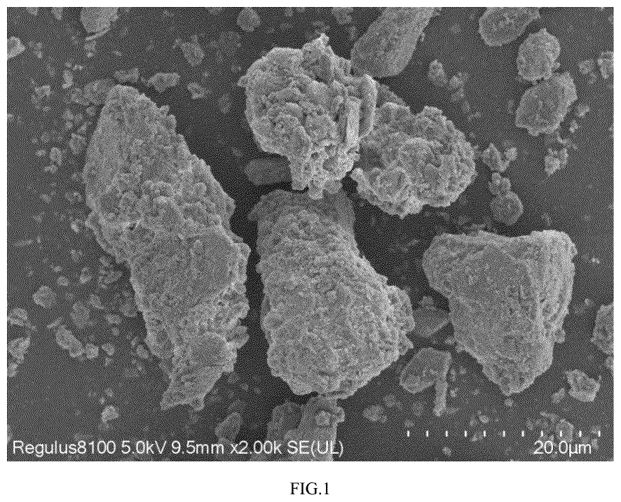

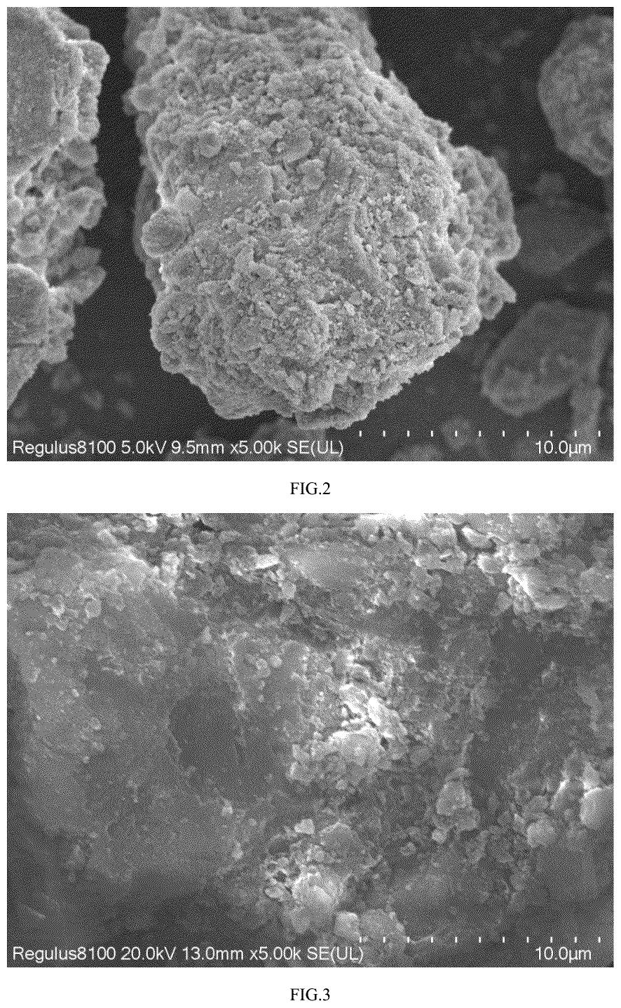

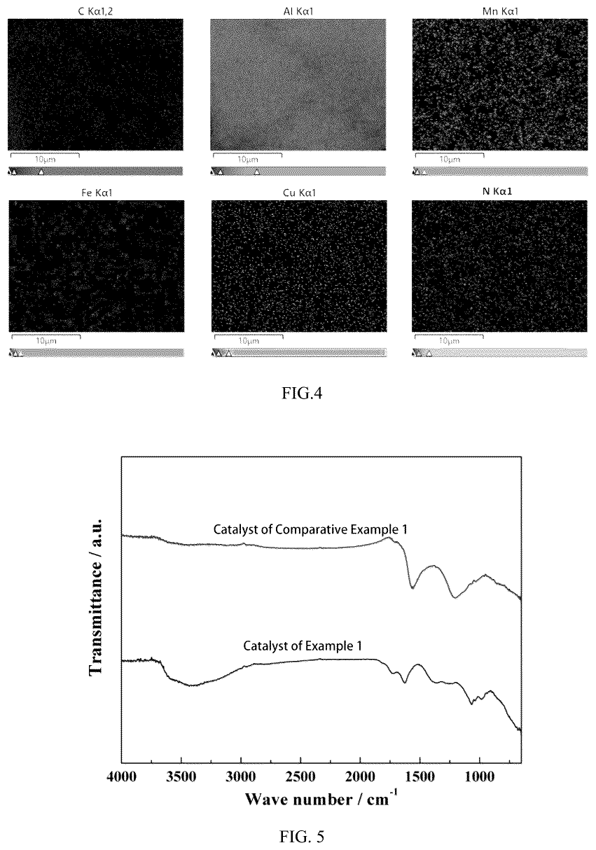

FIGS. 1 to 3 are FE-SEM images of catalysts prepared according to the present invention. FIG. 4 is the corresponding EDS spectrogram (10 μm) of the catalysts. It can be seen from FIG. 1 that after the calcination of the mixed powder, the material was cracked to produce a large number of particle Al/C supported metal oxide microspheres with a diameter of 2-100 μm. After further enlargement, it can be seen from FIG. 2 that the surface structure of the microspheres is compact and presents a fragmented structure, indicating that the composite catalyst of the present invention used Al/C as a matrix on the surface of which the carbon particle and the metal oxide was attached to form a structure similar to a “screen,” which can control the entry and exit of substances to catalytically react with metal active sites on the surface and in the confined pores. By introducing the biochar, the specific surface area and surface active sites of the catalyst were increased, compared with a single alumina matrix. In addition, compared with three-dimensional spherical catalysts, micron-sized microspheres have a significantly lower unit mass and are more likely to form a fluidized state in the ozone oxidation system, thus improving the mass transfer efficiency of pollutants on the surface of the catalyst. It can be seen from the EDS spectrogram of FIG. 4 corresponding to FIG. 3 that Fe, Mn, and Cu are successfully introduced into the catalyst of the present invention and uniformly distributed on the enlarged particle microsphere but with lower content than the matrix materials Al and C.

### Example 2: Preparation of Catalyst

The catalyst was prepared according to the following steps:

### 1. Pulverizing and Mixing

Bark was selected as a biochar matrix material, pulverized to 100 meshes, washed 3 times with water, filtered with a sieve to remove the micro impurities and ash contained in the bark, and dried in an oven at 60° C. The alumina powder was uniformly mixed with the pulverized carbon material at a mass ratio of 1:2, called “mixed powder.”

### 2. Impregnating

Three metal salts, copper acetate, manganese sulfate, and ammonium cerium nitrate, were weighed at a molar ratio of n(Cu):n(Mn):n(Ce)=1:0.6:0.2 and dissolved in water to prepare a precursor solution. The mixed powder was placed in the precursor solution with stirring at a temperature of 30° C., placed at room temperature for aging for 12 h, and filtered to leave an impregnated powder. The powder was dried in an oven at a temperature of 120° C. for 6 h.

### 3. Granulating

The impregnated mixed powder was added with a polyvinyl pyrrolidone (PVP) solution with a mass fraction of 0.5% and then granulated by a wet granulation method to form a three-dimensional spherical material with a particle size of 5-8 mm.

### 4. Calcining

After the completion of granulation, the spherical material was placed in a nitrogen-protected furnace and subjected to programmed temperature treatment under an N₂ atmosphere (50-100 mL/min) preparation, including first raising the temperature from room temperature to 200° C. at 10° C./min and maintaining for 1 h; then raising to 600° C. at 5° C./min and maintaining for 3 h; and finally naturally cooling to room temperature, to obtain the catalyst material.

### Example 3

### 1. Pulverizing and Mixing

Sawdust was selected as a biochar matrix material, pulverized to 100 meshes, washed 2 times with water, filtered with a sieve to remove the micro impurities and ash contained in the sawdust, and dried in an oven at 60° C. The ceramsite was pulverized to 325 meshes and uniformly mixed with the pulverized carbon material at a mass ratio of 1:10, called “mixed powder.”

### 2. Impregnating

Three metal salts, ferric citrate, copper acetate, and ammonium cerium nitrate, were weighed at a molar ratio of n(Cu):n(Fe):n(Ce)=1:0.8:0.4 and dissolved in water to prepare a precursor solution. The mixed powder was placed in the precursor solution with stirring at a temperature of 25° C., placed at room temperature for aging for 12 h, and filtered to leave an impregnated powder. The powder was dried in an oven at a temperature of 120° C. for 6 h.

### 3. Granulating

The impregnated mixed powder was added with a polyvinyl pyrrolidone (PVP) solution with a mass fraction of 1.5% and then granulated by a wet granulation method to form a three-dimensional spherical material with a particle size of 5-10 mm.

### 4. Calcining

After the completion of granulation, the spherical material was placed in a nitrogen-protected furnace and subjected to programmed temperature treatment under an N₂ atmosphere (50-100 mL/min) preparation, including first raising the temperature from room temperature to 200° C. at 10° C./min and maintaining for 1 h; then raising to 550° C. at 5° C./min and maintaining for 3 h; and finally naturally cooling to room temperature, to obtain the catalyst material.

### Comparative Example 1

Comparative Example 1 differs from Example 1 in that, after the metal salt impregnation, the granulation was carried out without the addition of a polyvinyl pyrrolidone solution, and the remaining steps, including pulverizing the mixed carrier material, metal impregnating, calcining, etc., had substantially the same conditions and parameters.

The specific preparation includes the following steps:
1) Pulverizing and mixing: the same step as in Example 1 was followed.
2) Impregnating: the same step as in Example 1 was followed.
3) Granulating: the impregnated mixed powder was granulated by a wet granulation method to form a three-dimensional spherical material with a particle size of 3-5 mm.
4) Calcining: the same step as in Example 1 was followed.

### Comparative Example 2

Comparative Example 2 differs from Example 1 in that the nitrogen element in the catalyst was derived from ammonium chloride instead of polyvinyl pyrrolidone, and the remaining conditions were substantially the same.

The specific preparation includes the following steps:
1) Pulverizing and mixing: the same step as in Example 1 was followed.
2) Impregnating: the same step as in Example 1 was followed.
3) Granulating: the impregnated mixed powder was added with an ammonium chloride solution with a mass fraction of 5% and then granulated by a wet granulation method to form a three-dimensional spherical material with a particle size of 3-5 mm.
4) Calcining: the same step as in Example 1 was followed.

It was found that the decomposition of ammonium chloride after heating during the preparation process would produce a large amount of ammonia-containing waste gas, which would easily cause environmental pollution. It was necessary to use water spray mode to absorb and secondary treat the waste gas, which increases the investment and operating cost of treatment facilities and is not beneficial for large-scale industrial production.

### Comparative Example 3

Comparative Example 3 differs from Example 1 in that the nitrogen source in the catalyst was derived from ammonium chloride instead of polyvinyl pyrrolidone, and a polyethylene solution was added as a binder during granulation. The remaining conditions were substantially the same.

The specific preparation includes the following steps:
1) Pulverizing and mixing: the same step as in Example 1 was followed.
2) Impregnating: the same step as in Example 1 was followed.
3) Granulating: the impregnated mixed powder was added with an ammonium chloride solution with a mass fraction of 5% and a polyethylene solution with a mass fraction of 2% and then granulated by a wet granulation method to form a three-dimensional spherical material with a particle size of 3-5 mm.
4) Calcining: the same step as in Example 1 was followed.

Similar to Comparative Example 2, it was found that the decomposition of ammonium chloride after heating during the preparation process would produce a large amount of ammonia-containing waste gas.

### Comparative Example 4

Comparative Example 4 differs from Example 1 in that the nitrogen element in the catalyst was derived from ammonium sulfate instead of polyvinyl pyrrolidone, and the remaining conditions were substantially the same.

The specific preparation includes the following steps:
1) Pulverizing and mixing: the same step as in Example 1 was followed.
2) Impregnating: the same step as in Example 1 was followed.
3) Granulating: the impregnated mixed powder was added with an ammonium sulfate solution with a mass fraction of 4.5% and then granulated by a wet granulation method to form a three-dimensional spherical material with a particle size of 3-5 mm.
4) Calcining: the same step as in Example 1 was followed.

Similar to Comparative Example 2, it was found that the decomposition of ammonium sulfate after heating during the preparation process would produce a large amount of ammonia-containing waste gas.

### Comparative Example 5

Comparative Example 5 differs from Example 1 in that the nitrogen element in the catalyst was obtained by introducing an ammonia gas atmosphere during calcination, and the remaining conditions were substantially the same.

The specific preparation includes the following steps:
1) Pulverizing and mixing: the same step as in Example 1 was followed.
2) Impregnating: the same step as in Example 1 was followed.
3) Granulating: the same step as in Comparative Example 1 was followed.
4) Calcining: after the completion of granulation, the spherical material was placed in a nitrogen-protected furnace and subjected to programmed temperature treatment under an ammonia gas atmosphere (50-100 mL/min) preparation, including first raising the temperature from room temperature to 200° C. at 10° C./min and maintaining for 1 h; then raising to 500° C. at 5° C./min and maintaining for 3 h; and finally naturally cooling to room temperature, to obtain the catalyst material.

Similar to Comparative Example 2, it was found that a large amount of ammonia-containing waste gas was produced during the preparation process.

### Comparative Example 6

Comparative Example 6 differs from Example 1 in that the carrier material of the catalyst was biochar as a single carrier without mixing the silica-alumina-based material, and the remaining preparation conditions were substantially the same.

The specific preparation includes the following steps:
1) Pulverizing: seed shell was selected as a biochar matrix material, pulverized to 50 mesh, washed 2 times with water, filtered with a sieve to remove the micro impurities and ash contained in the seed shell, and dried in an oven at 60° C.
2) Impregnating: three metal salts, ferric citrate, copper acetate, and manganese sulfate, were weighed at a molar ratio of n(Cu):n(Fe):n(Mn)=1:0.2:0.3 and dissolved in water to prepare a precursor solution. The biochar powder was placed in the precursor solution with stirring at a temperature of 15° C., placed at room temperature for aging for 12 h, and filtered to leave an impregnated powder. The powder was dried in an oven at a temperature of 101° C. for 24 h.
3) Granulating: the impregnated biochar powder was added with a polyvinyl pyrrolidone (PVP) solution with a mass fraction of 2% and then granulated by a wet granulation method to form a three-dimensional spherical material with a particle size of 3-5 mm.
4) Calcining: the same step as in Example 1 was followed.

### Comparative Example 7

Comparative Example 7 differs from Example 1 in that the carrier material of the catalyst was a silica-alumina-based material without mixing a biochar material.

The specific preparation includes the following steps:
1) Pulverizing: a 325 mesh alumina powder was selected, washed 2 times with water, and dried in an oven at 60° C.
2) Impregnating: three metal salts, ferric citrate, copper acetate, and manganese sulfate, were weighed at a molar ratio of n(Cu):n(Fe):n(Mn)=1:0.2:0.3 and dissolved in water to prepare a precursor solution. The alumina powder was placed in the precursor solution with stirring at a temperature of 15° C., placed at room temperature for aging for 12 h, and filtered to leave an impregnated powder. The powder was dried in an oven at a temperature of 101° C. for 24 h.
3) Granulating: the impregnated alumina powder was added with a polyvinyl pyrrolidone (PVP) solution with a mass fraction of 2% and then granulated by a wet granulation method to form a three-dimensional spherical material with a particle size of 3-5 mm.
4) Calcining: the same step as in Example 1 was followed.

### Comparative Example 8

Compared with Example 1, Comparative Example 8 has a different preparation method. The polyvinyl pyrrolidone was not added during granulation but during metal impregnation.

The specific preparation includes the following steps:
1) Pulverizing and mixing: the same step as in Example 1 was followed.
2) Impregnating: three metal salts, ferric citrate, copper acetate, and manganese sulfate, and polyvinyl pyrrolidone (PVP) were weighed at a molar ratio of n(Cu):n(Fe):n(Mn):n(N)=1:0.2:0.3:0.05 and dissolved in water to prepare a precursor solution. The mixed powder was placed in the precursor solution with stirring at a temperature of 15° C., placed at room temperature for aging for 12 h, and filtered to leave an impregnated powder. The powder was dried in an oven at a temperature of 101° C. for 24 h.
3) Granulating: the impregnated mixed powder was granulated by a wet granulation method to form a three-dimensional spherical material with a particle size of 3-5 mm.
4) Calcining: the same step as in Example 1 was followed.

The catalysts obtained in Example 1 and Comparative Example 1 were subjected to material characterization experiments and analyzed.

FIG. 5 is an FT-IR infrared spectrogram of the catalysts of Comparative Example 1 and Example 1. As can be seen from FIG. 5, the sample of Comparative Example 1 has distinct a —OH characteristic peak, a C═O characteristic peak, a C—C characteristic peak, and a C—O characteristic peak at 3380 cm⁻¹, 1725 cm⁻¹, 1625 cm⁻¹, and 1045 cm⁻¹, indicating that the catalyst sample obtained in Comparative Example 1 contains a large amount of oxygen-containing functional groups such as hydroxyl, carboxyl, carbonyl, epoxy, and the like. However, in the catalyst sample obtained in Example 1, due to the reduction of PVP, the characteristic peaks corresponding to the above oxygen-containing groups are significantly reduced or even disappeared. A C═C characteristic peak at 1590 cm⁻¹ and a C═N characteristic peak at 1240 cm⁻¹ are also observed, representing the sp² hybridized bonds of C═C bonds and the vibration generation of C—N bonds, respectively. This result shows that the catalyst material of Example 1 can be reduced by PVP, which can be doped into the catalyst as a nitrogen source to form a nitrogen-doped catalyst.

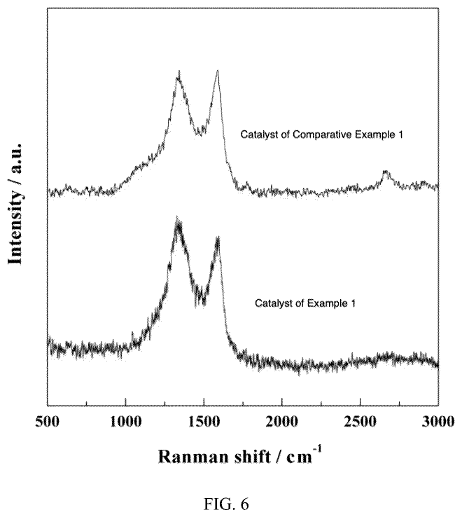

FIG. 6 is a Raman spectrogram of the catalysts of Comparative Example 1 and Example 1. Raman spectrum is widely used to characterize the structure and properties of carbon materials, especially to detect the degree of defects and order of carbon materials, because it does not damage the structure of materials during detection. As shown in FIG. 6, the surface structures of the catalysts of Comparative Example 1 and Example 1 were analyzed and compared using the Raman spectrum. The two most prominent peaks in the Raman spectrogram of the two samples are a G-band characteristic peak at about 1580 cm⁻¹ and a D-band characteristic peak at 1350 cm⁻¹. The G-band generally corresponds to the stretching vibration of sp² atomic bonds in the carbon material structure, and the D-band is associated with the sp³ defect region. The intensity ratio (ID/IG) of the D peak to the G peak indicates the degree of defects in the crystal structure. After the addition of polyvinyl pyrrolidone (PVP) in Example 1, the ID/IG value in the catalyst of Example 1 increased significantly compared with that of Comparative Example 1, from 0.98 to 1.11, indicating a further increase in defects in the crystal structure of the catalyst of Example 1, mainly due to nitrogen doping.

From the infrared spectrogram of FIG. 5 and the Raman spectrogram of FIG. 6, it can be demonstrated that the catalyst of Example 1 obtained by doping polyvinyl pyrrolidone (PVP) for granulation molding is indeed nitrogen-doped and does cause crystal defects due to nitrogen doping, which enhances its catalytic performance.

The catalysts prepared in Example 1, Comparative Example 2, and Comparative Example 6 were subjected to compressive strength tests. The test results are shown in the table below.

TABLE 1
Comparison of compressive strength tests

| | | Catalyst of | Catalyst of |
|---|---|---|---|
| | Catalyst of | Comparative | Comparative |
| Items | Example 1 | Example 2 | Example 6 |
| Compressive | 5.0 | 3.2 | 1.2 |
| strength (MPa) | | | |

By comparing the catalysts of Example 1 and Comparative Example 2, it can be seen that polyvinyl pyrrolidone (PVP) acts both as a nitrogen-containing precursor and as a binder. The strength of the catalyst of Comparative Example 2 prepared by using ammonium chloride as a nitrogen-containing precursor for granulation is significantly lower than that of the catalyst of Example 1 prepared by using PVP for granulation. The addition of PVP enhances the structural strength of the catalyst during granulation, while ammonium chloride does not.

By comparing the catalysts of Example 1 and Comparative Example 6, it can be seen that the strength of the catalyst of Comparative Example 6 prepared by using biochar as a single carrier for granulation is significantly lower than that of the catalyst of Example 1 prepared by using a mixture of alumina and biochar. The biochar carrier has low strength but good catalytic performance, and the alumina carrier has high strength and stability but not ideal catalytic performance. According to the present invention, a catalyst material with high strength and catalytic performance is developed by combining two carriers to form a co-carrier and using PVP for binding and granulation molding.

The catalysts of Comparative Examples 1-8 and the catalyst of Example 1 were used for the advanced treatment of RO membrane concentrated water from a certain electroplating park, with a COD of 140-160 mg/L, which needs to meet the first-class A discharge standard of national standards. The catalysts prepared in Comparative Examples and Example 1 were loaded into an ozone catalytic oxidation reactor for wastewater treatment. The wastewater was treated by ozone catalytic oxidation, and the removal rate of COD was used to reflect the reaction efficiency and effect, as well as catalytic performance.

Operating conditions for water treatment include an ozone dosage of 200 mg/L, a catalyst filling rate of 15% (v/v), and a water treatment time of 2 h.

TABLE 2
Comparison of the COD removal rates (%) of catalysts in ozone catalytic experiments

| | | Comparative | Comparative | Comparative | Comparative | Comparative | Comparative | Comparative | Comparative |
|---|---|---|---|---|---|---|---|---|---|
| Time/h | Example 1 | Example 1 | Example 2 | Example 3 | Example 4 | Example 5 | Example 6 | Example 7 | Example 8 |
| 0 | 0 | 0 | 0 | 0 | 0 | 0 | 0 | 0 | 0 |
| 0.5 | 18.5 | 5.5 | 6.8 | 7.1 | 5.7 | 6.6 | 5.1 | 3.2 | 10.5 |
| 1 | 32.1 | 10.1 | 12.2 | 13.5 | 11.8 | 14.5 | 14.5 | 8.5 | 22.6 |
| 1.5 | 46.8 | 17.6 | 19.4 | 21.9 | 17.6 | 20.5 | 22.6 | 12.4 | 30.8 |
| 2 | 55.2 | 20.5 | 23.2 | 25.2 | 22.8 | 24.8 | 26.8 | 17.9 | 35.6 |

As can be seen from the comparison of water treatment data in the above table:

In Example 1, by adding PVP with the function of both a binder and a nitrogen-containing precursor for granulation, the structural strength and catalytic performance of the catalyst can be strengthened, and the removal rate of COD can reach more than 50% in the actual ozone catalytic experiment.

In Comparative Example 1, no polyvinyl pyrrolidone was added, and the binder was absent. The catalyst has a lower structural strength, and in practical use, it is easily broken down by water flow and aeration, resulting in the loss of the catalyst and the reduction of treatment efficiency. In addition, since there is no nitrogen doping, an oxygen vacancy defect structure cannot be generated, and thus, the catalytic performance is poor.

In Comparative Example 2, ammonium chloride was added without a binder. The catalyst is easily broken down by water flow and aeration, resulting in the loss of the catalyst and the reduction of treatment efficiency.

In Comparative Example 3, ammonium chloride and polyethylene binder were added. PVP has a reducibility, but polyethylene has no reducibility. The catalyst of Comparative Example 3 cannot form oxygen vacancies on the surface of the metal oxide and thus has a poor effect compared with that of the catalyst of Example 1.

In Comparative Example 4, ammonium sulfate was added without a binder. The catalyst is easily broken down by water flow and aeration, resulting in the loss of the catalyst and the reduction of treatment efficiency.

In Comparative Example 5, ammonia gas was introduced. The nitrogen element can only be supported on the surface of the catalyst under the ammonia gas atmosphere, while nitrogen doping can be formed on both the surface and the inner core of the material by adding PVP during granulation, so the catalytic performance is poor compared with that of Example 1.

In Comparative Example 6, only biochar was added. The biochar material has low strength and is easily broken down by water flow and aeration, resulting in the loss of the catalyst and the reduction of treatment efficiency.

In Comparative Example 7, only the silica-alumina-based material was added without a biochar carrier. The catalyst has high strength, but the ozone catalytic performance is poor compared with that of Comparative Example 6.

In Comparative Example 8, PVP was added during impregnation. The PVP is easy to lose during the impregnation and leaching. The effect of granulation molding is poor compared with that of Example 1, in which the PVP solution was added during granulation. However, the effect of ozone catalysis on removing COD is still stronger than those of other Comparative Examples.

### Example 4: Use of Catalysts

The catalyst prepared in Example 1 was used to degrade RO membrane concentrated water from a centralized sewage plant in a certain chemical industrial park, with a COD of 150-200 mg/L, which needs to meet the first-glass A discharge standard of national standards. Three schemes were used for advanced treatment, including no catalyst (i.e., single ozone oxidation), filling with a commercial catalyst (i.e., ozone catalysis), and filling with the composite catalyst of Example 1 of the present invention (i.e., multi-source ozone catalysis). The matrix of the commercial catalyst described in this example was ceramsite, and the metal element composition included copper, manganese, and iron, where n(Cu):n(Fe):n(Mn)=1:0.5:0.5.
(1) For single ozone, no catalyst was filled, and the ozone dosage was 300 mg/L.
(2) For ozone catalysis, a commercial particle ceramsite catalyst was filled at a filling rate of 20% (v/v, the same below) of the total reactor volume, and the ozone dosage was 300 mg/L.
(3) For multi-source ozone catalytic oxidation 1, the catalyst of Example 1 was filled at a filling rate of 20% of the total reactor volume, and the ozone dosage was 100 mg/L.
(4) For multi-source ozone catalytic oxidation 2, the catalyst of Example 1 was filled at a filling rate of 10% of the total reactor volume, and the ozone dosage was 300 mg/L.

The remaining reaction conditions were substantially the same.

TABLE 3
Comparison of catalytic oxidation removal effect of no catalyst/commercial
catalyst/catalyst of the present invention

| | | | | | | Catalyst 1 | | Catalyst 2 | |
|---|---|---|---|---|---|---|---|---|---|
| | | | | | | of the present | | of the present | |
| | | No catalyst | | Commercial catalyst | | invention | | invention | |
| | | COD | Removal | COD | Removal | COD | Removal | COD | Removal |
| Number | Time/h | (mg/L) | rate (%) | (mg/L) | rate (%) | (mg/L) | rate (%) | (mg/L) | rate (%) |
| 1 | 0 | 135.8 | 0.00 | 140.2 | 0.00 | 139.6 | 0.00 | 146.9 | 0.00 |
| 2 | 0.5 | 123.9 | 8.76 | 123.6 | 11.84 | 102.3 | 26.72 | 109.8 | 25.26 |
| 3 | 1 | 112.6 | 17.08 | 112.3 | 19.90 | 82.9 | 40.62 | 87.6 | 40.37 |
| 4 | 1.5 | 105.6 | 22.24 | 98.6 | 29.67 | 61.8 | 55.73 | 68.4 | 53.44 |
| 5 | 2 | 102.8 | 24.30 | 89.9 | 35.88 | 48.7 | 65.11 | 58.9 | 59.90 |

It can be seen from the above experimental data that the removal rate of COD by using the single ozone oxidation was only 24.30%, and the removal rate of COD by ozone oxidation using the commercial catalyst was 35.88%. However, by using the ozone catalyst of the present invention, the removal rate of COD of more than 60% can be achieved under the condition that the filling amount of the catalyst was reduced by 50% or the ozone dosage was reduced by more than 50%. In practical operation, the use of the ozone catalyst of the present invention can significantly reduce the integrated operation cost of the ozone catalytic oxidation technology.

### Example 5: Use of Catalysts

The catalyst prepared in Example 2 was used for the biochemical effluent from a certain industrial enterprise, with a COD of 800-1000 mg/L, which needs to meet the local sewage pipe network connection standard (COD≤500 mg/L). Three technologies were used for advanced treatment, including no catalyst (single ozone oxidation), filling with a commercial catalyst (ozone catalysis), and filling with the composite catalyst of Example 2 of the present invention (multi-source ozone catalysis). The commercial catalyst used in this Example was the same as the commercial catalyst in Example 4.
(1) For single ozone, no catalyst was filled, and the ozone dosage was 1250 mg/L.
(2) For ozone catalysis, a commercial particle ceramsite catalyst was filled at a filling rate of 20% of the total reactor volume, and the ozone dosage was 1250 mg/L.
(3) For multi-source ozone catalytic oxidation 1, the catalyst of Example 2 was filled at a filling rate of 20% of the total reactor volume, and the ozone dosage was 750 mg/L.
(4) For multi-source ozone catalytic oxidation 2, the catalyst of Example 2 was filled at a filling rate of 10% of the total reactor volume, and the ozone dosage was 1250 mg/L.

TABLE 4
Comparison of catalytic oxidation removal effect of no catalyst/commercial
catalyst/catalyst of the present invention

| | | | | | | Catalyst 1 | | Catalyst 2 | |
|---|---|---|---|---|---|---|---|---|---|
| | | | | | | of the present | | of the present | |
| | | No catalyst | | Commercial catalyst | | invention | | invention | |
| | | COD | Removal | COD | Removal | COD | Removal | COD | Removal |
| Number | Time/h | (mg/L) | rate (%) | (mg/L) | rate (%) | (mg/L) | rate (%) | (mg/L) | rate (%) |
| 1 | 0 | 869.8 | 0.00 | 895.7 | 0.00 | 902.5 | 0.00 | 882.9 | 0.00 |
| 2 | 0.5 | 758.5 | 12.80 | 732.5 | 18.22 | 674.1 | 25.31 | 695.1 | 21.27 |
| 3 | 1 | 699.8 | 19.54 | 645.7 | 27.91 | 565.4 | 37.35 | 598.5 | 32.21 |
| 4 | 1.5 | 623.5 | 28.32 | 589.6 | 34.17 | 485.7 | 46.18 | 501.2 | 43.23 |
| 5 | 2 | 586.9 | 32.52 | 523.7 | 41.53 | 452.8 | 49.83 | 463.8 | 47.47 |

It can be seen from the above experimental data that the removal rate of COD by using the single ozone oxidation was only 32.52%, and the removal rate of COD by ozone oxidation using the commercial catalyst was 41.53%. However, by using the ozone catalyst of the present invention, the removal rate of COD of about 50% can be achieved under the condition that the filling amount of the catalyst was reduced by 50% or the ozone dosage was reduced by more than 50%. In practical operation, the use of the ozone catalyst of the present invention can significantly reduce the integrated operation cost of the ozone catalytic oxidation technology.

### Example 6: Ozone Oxidation Experiment for Printing and Dyeing Wastewater

The biochemical effluent from a centralized sewage plant in a printing and dyeing park, with a COD of 80-100 mg/L, needs to meet the first-class A discharge standard of national standards. Three schemes were used for advanced treatment, including no catalyst (single ozone oxidation), filling with a commercial catalyst (ozone catalysis), and filling with the composite catalyst of the present invention (multi-source ozone catalysis). The commercial catalyst used in this Example was the same as the commercial catalyst in Example 4.
(1) For single ozone, no catalyst was filled, and the ozone dosage was 150 mg/L.
(2) For ozone catalysis, a commercial particle ceramsite catalyst was filled at a filling rate of 20% of the total reactor volume, and the ozone dosage was 90 mg/L.
(3) For multi-source ozone catalytic oxidation, the catalyst prepared in Example 2 of the present invention was filled at a filling rate of 10% of the total reactor volume, and the ozone dosage was 60 mg/L.

TABLE 5
Comparison of catalytic oxidation removal effect of no catalyst/commercial
catalyst/catalyst of the present invention

| | | | | | | Catalyst of the | |
|---|---|---|---|---|---|---|---|
| | | No catalyst | | Commercial catalyst | | present invention | |
| | Time | COD | Removal | COD | Removal | COD | Removal |
| Number | h | (mg/L) | rate (%) | (mg/L) | rate (%) | (mg/L) | rate (%) |
| 1 | 0 | 83.52 | 0.00 | 81.97 | 0.00 | 82.63 | 0.00 |
| 2 | 0.5 | 78.56 | 5.94 | 75.45 | 7.95 | 67.41 | 18.42 |
| 3 | 1 | 73.62 | 11.85 | 68.51 | 16.42 | 56.99 | 31.03 |
| 4 | 1.5 | 69.55 | 16.73 | 63.65 | 22.35 | 46.98 | 43.14 |
| 5 | 2 | 67.52 | 19.16 | 58.78 | 28.29 | 43.65 | 47.17 |

TABLE 6
Removal efficiency for
characteristic emerging pollutants (units: %)

| | No | Commercial | Catalyst of the |
|---|---|---|---|
| Pollutants | catalyst | catalyst | present invention |
| 2,4-di-tert- | 12.0 | 25.6 | 87.9 |
| butylphenol | | | |
| 2,6- | 4.8 | 7.6 | 90.2 |
| Dichloronitrosobenzene | | | |
| Cathinone | 5.4 | 15.4 | 89.9 |
| Dibutyl phthalate | 3.6 | 12.6 | 92.3 |

As can be seen from the removal rate for the characteristic pollutants, the catalyst of the present invention can generally improve the removal efficiency for the characteristic emerging pollutants. Compared with the single ozone without a catalyst and the ozone catalysis of the commercial catalyst, the adsorption sites and active sites of the catalyst of the present invention were richer, resulting in a higher selective removal rate for the characteristic pollutants.

### Example 7: Ozone Oxidation Experiment for Chemical Wastewater

The biochemical effluent from a centralized sewage plant in a chemical industrial park, with a COD of 40-50 mg/L, needs to be upgraded to the surface water environmental quality standard (quasi-Class IV standard, COD≤30 mg/L). Three technologies were used for advanced treatment, including single ozone oxidation without a catalyst, ozone catalysis filled with a commercial catalyst, and multi-source ozone catalysis filled with the catalyst of the present invention. The commercial catalyst used in the Example was the same as the commercial catalyst in Example 4.
(1) For single ozone, no catalyst was filled, and the ozone dosage was 50 mg/L.
(2) For ozone catalysis, a commercial particle ceramsite catalyst was filled at a filling rate of 20% of the total reactor volume, and the ozone dosage was 30 mg/L.
(3) For multi-source ozone catalytic oxidation 1, the catalyst prepared in Example 3 of the present invention was filled at a filling rate of 10% of the total reactor volume, and the ozone dosage was 30 mg/L.
(4) For multi-source ozone catalytic oxidation 2, the catalyst prepared in Example 3 of the present invention was filled at a filling rate of 20% of the total reactor volume, and the ozone dosage was 30 mg/L.

TABLE 7
Comparison of the removal effects of single ozone/ozone
catalysis/multi-source ozone catalytic oxidation

| | | | | | | Catalyst 1 | | Catalyst 2 | |
|---|---|---|---|---|---|---|---|---|---|
| | | | | | | of the present | | of the present | |
| | | No catalyst | | Commercial catalyst | | invention | | invention | |
| | Time | COD | Removal | COD | Removal | COD | Removal | COD | Removal |
| Number | h | (mg/L) | rate (%) | (mg/L) | rate (%) | (mg/L) | rate (%) | (mg/L) | rate (%) |
| 1 | 0 | 45.69 | 0.00 | 48.52 | 0.00 | 52.25 | 0.00 | 46.98 | 0.00 |
| 2 | 0.5 | 42.8 | 6.33 | 44.6 | 8.54 | 37.6 | 28.04 | 40.14 | 14.56 |
| 3 | 1 | 41.5 | 9.17 | 41.6 | 13.25 | 32.5 | 37.80 | 36.5 | 22.31 |
| 4 | 1.5 | 40.6 | 11.14 | 38.2 | 19.52 | 25.6 | 51.00 | 31.4 | 33.16 |
| 5 | 2 | 39.8 | 12.89 | 36.9 | 23.25 | 22.5 | 56.94 | 28.5 | 39.34 |

TABLE 8
Removal efficiency for
characteristic emerging pollutants (units: %)

| | | | Catalyst 2 of |
|---|---|---|---|
| | No | Commercial | the present |
| Pollutants | catalyst | catalyst | invention |
| Bisphenol A | 12.1 | 9.6 | 92.68 |
| Bisphenol A | 3.6 | 10.20 | 95.25 |
| Bromophenol blue | 2.4 | 12.6 | 93.64 |
| Bisphenol AP | 8.8 | 23.6 | 95.12 |
| Norfloxacin | 0.6 | 10.17 | 92.25 |
| Ofloxacin | 1.6 | 18.4 | 93.65 |
| Monobutyl | 5.6 | 13.69 | 84.95 |
| phthalate | | | |
| Triphenylphosphine | 8.4 | 25.84 | 90.25 |
| oxide | | | |

As can be seen from the removal rate for the characteristic pollutants, the catalyst of the present invention can generally improve the removal efficiency for the characteristic emerging pollutants. The adsorption sites and active sites of the catalyst of the present invention were richer, resulting in a higher selective removal rate for the characteristic pollutants.

Although the present invention has been described in detail with reference to specific embodiments and illustrative examples, the description should not be construed as limiting the present invention. It will be understood by those skilled in the art that various equivalents, modifications, and improvements may be made to the technical solutions and embodiments of the present invention without departing from the spirit and scope of the present invention, and all these fall within the scope of the present invention.

1. A composite ozone catalyst, comprising a co-carrier mixed with biochar and a silica-alumina-based material, and a metal element and a nitrogen element supported on the co-carrier, wherein the source of the nitrogen element comprises polyvinyl pyrrolidone.

2. The composite ozone catalyst according to claim 1, wherein the biochar comprises any one or a combination of straw, seed shell, bark, and sawdust; the silica-alumina-based material comprises any one or a combination of alumina, ceramsite, or zeolite; the metal element comprises any one or a combination of iron, copper, manganese, cobalt, nickel, lanthanum, and cerium.

3. The composite ozone catalyst according to claim 1, wherein the mass ratio of the biochar to the silica-alumina-based material is 1:(2-10).

4. The composite ozone catalyst according to claim 1, wherein the metal element comprises any one or a combination of copper, iron, manganese, and cerium, with a molar concentration ratio of n(Cu):n(Fe):n(Mn):n(Ce)=1:(0-0.8):(0-0.6):(0-0.4).

5. The composite ozone catalyst according to claim 1, wherein a preparation method for the composite ozone catalyst comprises mixing the biochar and the silica-alumina-based material and then placing the same in a metal precursor solution for impregnation, adding a polyvinyl pyrrolidone solution to the impregnated material, wet granulating to form a spherical material, and calcining the spherical material to obtain the composite ozone catalyst.

6. The composite ozone catalyst according to claim 5, wherein the polyvinyl pyrrolidone solution has a concentration of 0.5-3 wt %.

7. The composite ozone catalyst according to claim 6, wherein the metal precursor solution is an aqueous solution of a metal salt, and the metal salt is any one or a combination of at least two of metal citrate, metal acetate, metal sulfate, and metal nitrate.

8. An ozone catalytic oxidation reactor for wastewater, wherein the reactor is filled with the composite ozone catalyst according to claim 1.

9. The ozone catalytic oxidation reactor for wastewater according to claim 8, wherein the filling rate of the composite ozone catalyst in the reactor is 3%-15% of the total reactor volume.

10. Use of the composite ozone catalyst according to claim 1 in wastewater treatment.

11. The use according to claim 10, wherein the wastewater to be treated is introduced into the ozone catalytic oxidation reactor for wastewater containing the composite ozone catalyst for wastewater treatment.

12. The use according to claim 11, wherein ozone is introduced into the ozone catalytic oxidation reactor for wastewater; the ozone dosage is determined as O₃/ΔCOD=(1.0-2.5):1, where O₃ and COD have the same units.

13. The use according to claim 11, wherein the O₃/ΔCOD ratio is (1.0-2.0):1 when the influent COD of the wastewater to be treated is 50-200 mg/L; the O₃/ΔCOD ratio is (1.5-2.5):1 when the influent COD of the wastewater to be treated >500 mg/L; where O₃ and COD have the same units.
